(19) United States
(12) Patent Application Publication
(10) Pub. No.: US 2019/0155645 A1
(43) Pub. Date: May 23, 2019

(54) DISTRIBUTION OF NETWORK TRAFFIC TO PROCESSOR CORES

(71) Applicant: Intel Corporation, Santa Clara, CA (US)

(72) Inventors: John J. BROWNE, Limerick (IE); Chris MACNAMARA, Limerick (IE); Tomasz KANTECKI, Ennis (IE)

(21) Appl. No.: 16/255,480

(22) Filed: Jan. 23, 2019

(51) Int. Cl. G06F 9/48; G06F 9/50

(52) U.S. Cl. CPC G06F 9/4881; G06F 9/5027

(57) ABSTRACT

Packets received at an input port can be sub-divided into timeslots. A core or thread can process packets associated with a timeslot. The timeslot size can be increased or decreased based on utilization of a core that is allocated to process packets associated with a timeslot. A timeslot number can be assigned to each received packet. For transmission of the received packets, the timeslot number can be used to maintain an order of transmission to attempt to reduce out-of-order packet transmission.

### TECHNICAL FIELD

Various examples described herein relate to techniques for allocating packet processing among processor devices.

### BACKGROUND

As the number of devices connected to the Internet grows, increasing amounts of data and content are transmitted using network interfaces, switches, and routers, among others. As packet transmission rates increase, the speed at which packet processing is to take place has also increased. Techniques such as Receive Side Scaling (RSS) can be used to allocate received packets across multiple cores for packet processing to balance the load of packet processing among cores.

### BRIEF DESCRIPTION OF THE DRAWINGS

FIG. 1 depicts a manner of distributing received packets among multiple cores.

FIG. 2 depicts an example system.

FIG. 3 depicts an example of allocations of packets to a timeslot.

FIG. 4 depicts an example system.

FIG. 5 depicts an example whereby packets from output timeslot queues are allocated for transmission from an output port.

FIG. 6 depicts an example process.

FIG. 7 depicts a system.

FIG. 8 depicts a network interface.

FIG. 9 depicts a switch.

FIG. 10 depicts an example of a data center.

### DETAILED DESCRIPTION

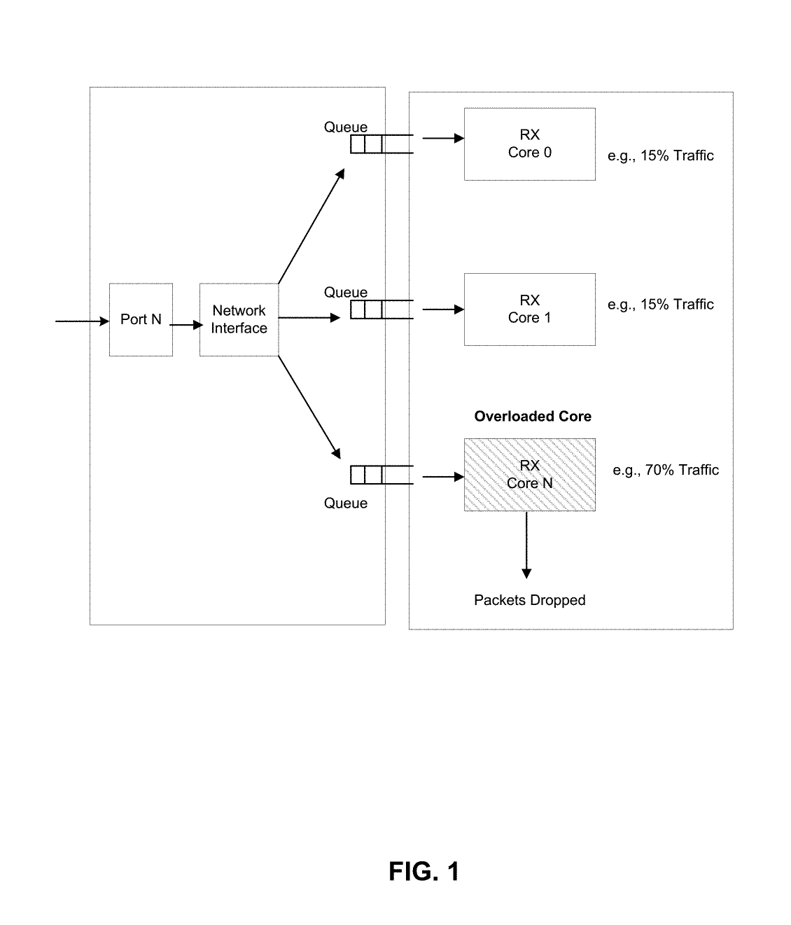

FIG. 1 depicts a manner of distributing received packets among multiple cores for processing using RSS or other schemes that use a hash of contents of a received packet to select a core to process the packet. A hash can be calculated on a portion of a packet and the hash value can be used to allocate the packet to a core for processing. In the case of an occurrence of high packet receipt rates for a particular flow (e.g., elephant flows), a large portion of the packets can be allocated for processing by a particular core. The particular core may become overloaded and drop packets. However, other cores can be underutilized. In the case of distributing elephant flows among multiple cores, packet order may be disrupted and packet re-ordering may need to be implemented. In some cases, re-ordering packets can reduce packet processing capacity of the cores.

According to some embodiments, packets received at a port of a network interface from a network medium can be divided into timeslots and allocated into corresponding input timeslot queues. One or more cores can process packets allocated to an input timeslot queue. A timeslot size can be adjusted based on utilization of the one or more cores allocated to process an input timeslot queue. For example, if one or more cores allocated to process an input timeslot queue are overloaded, then the timeslot size can be reduced so that the one or more cores are to process fewer packets and thereby the one or more cores are less likely to become overloaded. Processed packets can be allocated to an output timeslot queue and an output port. In some examples, processed packets associated with the same input timeslot queue can be allocated to the same output timeslot queue to attempt to maintain packet ordering according to order of packet receipt and to attempt to prevent packet re-ordering. A need to perform re-ordering can be avoided (e.g., for elephant or other flows) as the packets processed by cores have an associated timeslot number, which can be used by the cores to maintain a packet order when processing packets and for packet transmission. A transmit interface combiner can multiplex packets from multiple output timeslot queues for transmission from an output port.

According to some embodiments, a network interface uses an interface divider to divide or split packets or traffic received at a port into multiple input timeslot queues based on a timeslot allocation. A received packet can be allocated to a timeslot according to a time of receipt by a network interface. In some embodiments, the timeslots are equal size in terms of time duration. A core can be allocated to an input timeslot queue to process associated received packets. A host processor (or other software) can configure the timeslot size to match an expected maximum rate that the receiving core can process. As a result, traffic loads at a port can be evenly distributed across cores. Dividing packets into timeslots and adjusting a timeslot duration can potentially reduce the likelihood of a core being overloaded by packet processing or underutilized for packet processing. Various embodiments can be used by an endpoint network interface, router, or switch.

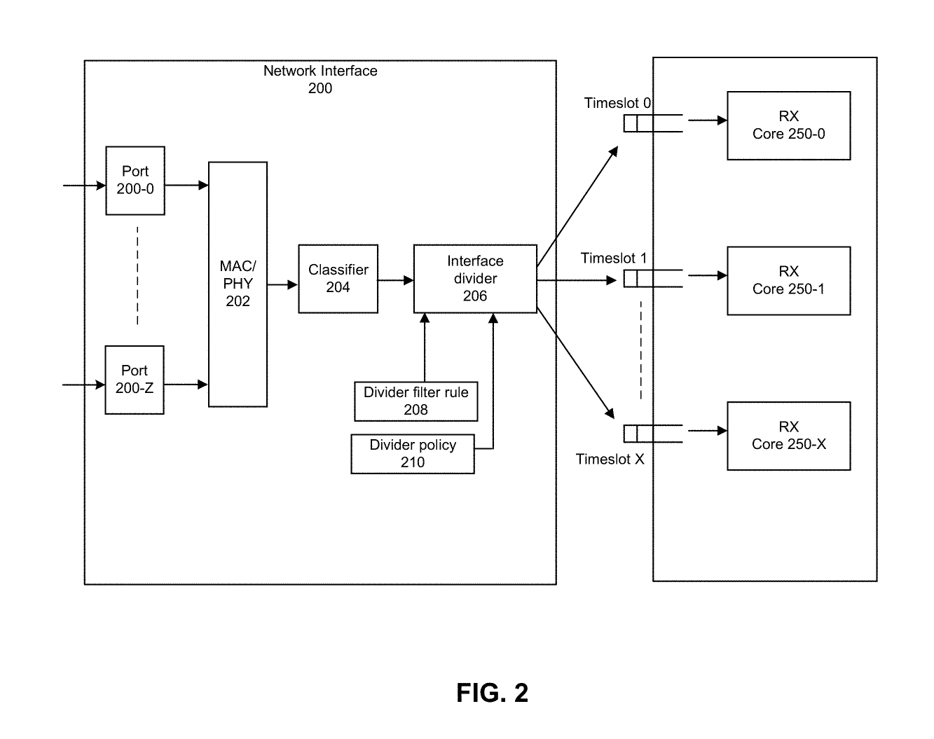

FIG. 2 depicts an example system. In this system, network interface 200 can include multiple ports 200-0 to 200-Z that can receive packets from a network medium. In this example, only receive packet traffic flow is shown and network interface 200 can also process and provide packets for transmission. Media access control (MAC)/physical layer (PHY) circuitry 202 can provide decoding of packets according to applicable physical layer specifications or standards and disassembly of data from packets based on destination and source addresses along with network control information and error detection hash values. Classifier 204 can determine a classification of a received packet. For example, classifier 204 can determine a flow associated with a Transmission Control Protocol (TCP) packet from one or more of: destination port, destination Internet Protocol (IP) address, destination port, or destination IP address. Classifier 204 can determine flow characteristics from other aspects of a received packet such as a connection identifier (e.g., connection ID from IETF Quick UDP Internet Connections (QUIC), protocol), an HyperText Transfer Protocol (HTTP) header, or other characteristics of a packet header or payload.

Interface divider 206 can subdivide received packets received from a port (e.g., 200-0) into a group of lower rate input timeslot queues based on a divider filter rule and divider policy. Interface divider 206 can split the incoming traffic from a port into N timeslots and allocate each timeslot to a unique queue to be processed by a core. For example, interface divider 206 can divide a flow determined by classifier 204 in the time domain. A host CPU can configure interface divider 206 with a divider filter rule 208 which specifies a filter rule that identifies the traffic to be divided into timeslots according to divider policy 210. Classifier 204 and interface divider 206 can be utilized for one or multiple input ports. In some embodiments, a single packet is not split or placed into multiple timeslots, rather a single packet is allocated into a single timeslot. In some embodiments, multiple packets can be allocated to a timeslot. In some embodiments, a single packet can be split among multiple timeslots.

Divider filter rule 208 can define one or more of: input port to divide, IP 5tuple of the received traffic (e.g., source IP address, source port number, destination IP address, destination port number, and protocol in use), protocol type of traffic to divide (e.g., TCP, User Datagram Protocol (UDP), Internet Control Message Protocol (ICMP)), quality of service (QoS) field of the traffic (e.g. IP Differentiated Services Code Point (DSCP) defined in RFC791, Priority Code Point (PCP) field in the 802.1Q tag (also termed as Class of Service (CoS)), or Traffic Class (e.g., real time, best effort)), or associated divider policy. Divider policy 210 can specify one or more of: timeslot duration (e.g., microseconds, nanoseconds), number of timeslots to use, number of queues associated with the timeslots, or address/index of the queues.

A time at which a packet is received at a network interface or a time that the received packet is stored in memory of network interface 200 can be used to determine a time stamp. A time stamp that fits within a timeslot can be used to allocate a corresponding packet to a timeslot. For example, for a timeslot duration of 1 microsecond, packets received with timestamps of greater than 0 and up to 1 microseconds can be allocated to a timestamp beginning at 0 microsecond and ending at 1 microsecond, packets received with timestamps of greater than 1 microsecond and up to 2 microseconds can be allocated to a timestamp starting after 1 microsecond and ending at 2 microseconds, and so forth. For example, a received packet with a timeslot of 0.06 microseconds can be allocated to a timeslot 0, a received packet with a timestamp of 1.11 microseconds can be allocated to a timeslot 1, and so forth.

Timeslot duration can be a function of (number of packets at fastest per packet arrival time*processing time per packet). A duration of a timeslot (in seconds) determines the maximum latency of a packet. A duration is greater than a highest (fastest) per-packet arrival time and is an even number to allow an even number of timeslots per second. Timeslot duration can be chosen to achieve or fall below a maximum packet latency.

According to some embodiments, a number of timeslots can be selected in a manner described below:

Minimum number of timeslots (and cores)=N/R, where
N=worst case packet rate (e.g., highest packet arrival rate).
R=Packet processing rate of a core, where R=1/T.
T=Time to process a packet (e.g., time to receive packet+total time to process packet+time to transmit packet). This assumes processing time is fixed for a given processor at a given processor frequency and processing is applied per packet over the header and is independent of payload length.

In some embodiments, if one or more cores are determined to be overloaded or packet processing latency is excessive, a timeslot size can be adjusted to be smaller. The number of input timeslot queues can be increased for a smaller timeslot size. In addition, a number of cores can be increased so that cores can process fewer packets from each input timeslot queue. Conversely, if one or more cores are determined to be underutilized and packet processing latency is acceptable, a timeslot size can be adjusted to be larger. A number of input timeslot queues (and cores) can be decreased for a larger timeslot size. In addition, a number of cores can be decreased so that cores can process more packets from each input timeslot queue.

Various embodiments provide for maintaining an order of received packets by allocating received packets to timeslots and maintaining timeslot designations for the received packets. For example, a processor (e.g., host central processing unit (CPU), hypervisor, or other manager) configures interface divider 206 to divide packets received at port 200-0 (e.g., receiving traffic at 100 Gbps) into 10 receive queues. The processor can write a divider filter rule 208 that specifies all traffic on port 200-0 of type UDP and traffic class real-time uses divider policy 1. The processor writes divider policy 1 into divider policy 210. In this example, divider policy 1 uses a timeslot size of 1 microsecond and there are 10 total timeslots. The processor specifies 10 queues, one queue for each timeslot. Interface divider 206 increments a timeslot sequence number every 1 microsecond, then resets to 1 after counting to 10. The 1 microsecond interval can be based on a clock with a 1 microsecond period or fraction or multiple thereof. For a received packet, interface divider 206 checks divider filter rule 208 to determine a divider policy to apply to the received packet. For example, for a received packet of type UDP and traffic class real-time, interface divider 206 applies divider policy 1 whereby received packets of type UDP and traffic class real-time are allocated to one of 10 timeslot queues. Interface divider 206 checks a current timestamp of a received packet of type UDP and traffic class real-time and maps the received packet to a timeslot queue associated with the current timestamp.

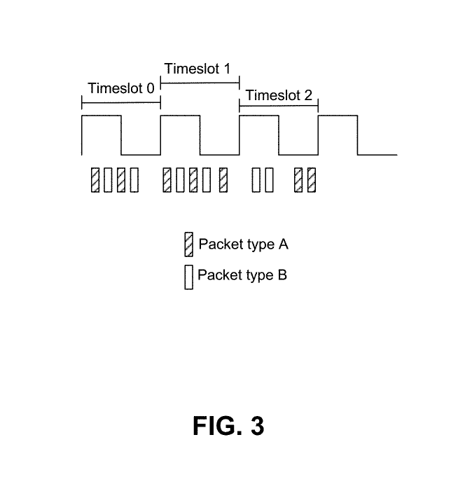

For example, FIG. 3 depicts an example of receipt of packets of type A and B at an input port. In this example, packet type A is type UDP and traffic class real-time but packet type B is type TCP and traffic class best effort. In this example, interface divider 206 is to allocate packet type A to a timeslot of 1 microsecond length. Packets of type A with a timestamp occurring during the timeslot 0 are allocated to a queue associated with timeslot 0, packets of type A with a timestamp occurring during the timeslot 1 are allocated to a queue associated with timeslot 1, and so forth.

Referring again to FIG. 2, queues for timeslot0 and so forth can be allocated in host memory or a cache (e.g., a cache dedicated to a core or shared between or among cores). A direct memory access (DMA) operation can be used to copy portions of packets from network interface 200 to a host memory or cache (not depicted). For a received packet, network interface 200 can complete a descriptor specifying information concerning the received packet, including one or more of: timeslot number or input timeslot index (0 . . . X). If traffic is not received during a timeslot, a descriptor is sent at the end of the timeslot, with a zero payload indicating zero packets received for that period.

Cores 250-0 to 250-X can process received packets allocated to an input timeslot queue. Core 250-0 reads and processes the packets for timeslot0 on the associated queue. Similarly, core 250-1 reads and processes the packets for timeslotl on the associated queue, and so forth. Accordingly, packets of a particular type and class, among other features, can be allocated to an input timeslot so that time-based distribution can be used for packets. Processing of received packets can include one or more of: determination if a packet is valid (e.g., correct Ethernet type, correct checksum, correct IP Protocol type, valid Layer 4-7 Protocol type), determination of packet destination (e.g., next hop, destination queue), use of Data Plane Development Kit (DPDK) or OpenDataPlane to perform one or more of: IP Filter checks, flow table lookup, outgoing port selection using a forwarding table, packet decryption, packet encryption, denial of server protection, packet counting, billing, traffic management/conditioning, traffic shaping/traffic scheduling, packet marking/remarking, packet inspection L4-L7, or traffic load balancing/load distribution. Processed packets can be stored in host memory accessible to the cores.

A core can be an execution core or computational engine that is capable of executing instructions. Each core can have access to their own cache and read only memory (ROM), or they can share cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores can also include a system agent. System agent can include or more of: a memory controller, a shared cache, a cache coherency manager, arithmetic logic units, floating point units, core or processor interconnects, or bus or link controllers. System agent can provide one or more of: DMA engine connection, non-cached coherent master connection, data cache coherency between cores and arbitrates cache requests, or Advanced Microcontroller Bus Architecture (AMBA) capabilities.

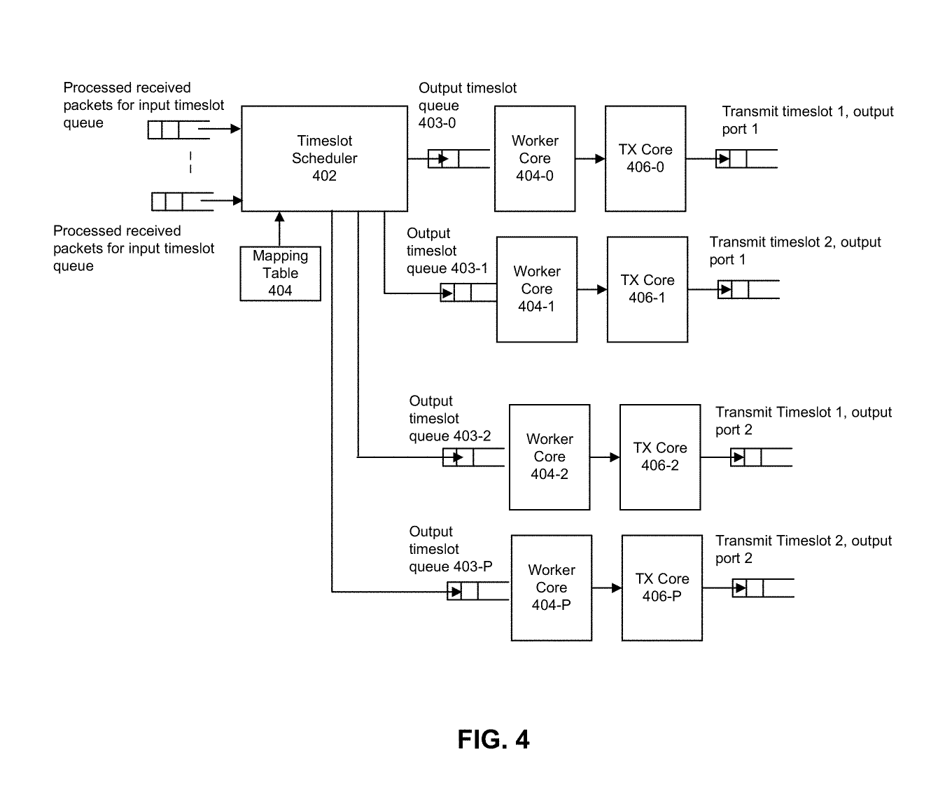

FIG. 4 depicts an example system. The system of FIG. 4 can allocate contents (e.g., processed received packets) associated with input timeslot queues and processed by cores to specific output timeslot queues and specific output ports. One or more cores can execute or use timeslot scheduler 402 to determine an output timeslot queue and an output port for processed received packets. By allocating a processed received packet to an output timeslot queue, timeslot scheduler 402 can determine which worker core to allocate to process a packet (or portion thereof) associated with an output timeslot queue. The system of FIG. 4 can be implemented in a host computer, host CPU, or network interface.

Timeslot scheduler 402 can be implemented as a single instance or multiple parallel instances of timeslot schedulers 402. For example, there could be one instance of timeslot scheduler 402 per output port which takes inputs from multiple incoming ports and timeslots. In some examples, an instance of timeslot scheduler 402 can support multiple outputs ports and multiple incoming ports and timeslots.

A received packet can have an associated receive descriptor, packet header and packet payload. In some examples, the receive descriptor can be replaced with meta-data whereby the meta-data identifies the packet header and payload and its incoming port and timeslot. The meta-data associated with the packet is modified to indicate the outgoing port, the packet can have a modified outgoing source and destination Ethernet address.

According to some embodiments, timeslot scheduler 402 can attempt to maintain receive packet order or reorder packets into an output timeslot queue (after out-of-order processing) using the timeslot number of the packet to maintain order. Because groups of packets are tagged that arrive with the timeslot they arrive in, an order of received packets, relative to each other, can be maintained. Timeslot scheduler 402 can attempt to prevent received packets from going out-of-order because all packets in an input timeslot stay together when mapped and scheduled to transmit timeslots and output ports.

In some embodiments, timeslot scheduler 402 can allocate a packet to an output timeslot queue and output port for a packet using mapping table 404. Mapping table 404 can indicate an output timeslot queue and an output port for each input timeslot queue and input port combination. A host device (processor) or administrator can program mapping table 404 to allocate packets to output timeslot queue and output port based on one or more of: IP header, input timeslot queue number, or receive port number.

Based on mapping table 404, timeslot scheduler 402 can assign packets to an output timeslot queue having the same number or index as that of the input timeslot queue in order to maintain a receive order of packets, where the output timeslot queues are associated with the same output port. In a case where an output timeslot queue is full or overflowing or its associated core is not able to process packets rapidly enough and has introduced delay or is dropping packets, timeslot scheduler 402 can select another output timeslot queue with a different number or index but for the same output port. Timeslot scheduler 402 can detect overflow of an output timeslot queue and change mapping table 404 to divert packets to another output timeslot queue. Timeslot scheduler 402 can monitor the usage of outgoing timeslot queues and drop packets from one or more output timeslot queue for a congested output port.

Timeslot scheduler 402 can allocate packets to output timeslot queues and ports based on fullness or overflow conditions of output timeslot queues and output ports or other factors. Timeslot scheduler 402 can select an output timeslot queue index and output port number based on utilization of an associated worker core and TX core.

For example, where received packets with an input timeslot queue index of 1 and an input port 0 are allocated to an output timeslot queue index of 1 and an output port 0. In a case where the output timeslot queue index of 1 for output port 0 is full or overflowing or its associated worker or TX core is not able to process packets rapidly enough and has introduced delay or is dropping packets, packets allocated to output timeslot queue index of 1 for output port 0 are allocated to output timeslot queue index of 4 and an output port 0. Accordingly, any packets received for input timeslot queue index of 1 and an input port 0 after the new allocation are allocated to the output timeslot queue index of 4 and an output port 0. Mapping table 404 can be updated with the updated mapping of output timeslot queue index of 4 for output port 0 allocated for an input timeslot queue index of 1 for input port 0.

In some embodiments, packets allocated to an input timeslot can be split into multiple portions and each of the portions is allocated to an output timeslot queue for an output port. For example, an input timeslot 1 for input port 1 can receive packet types A and B. For example, type A can be UDP and type B can be TCP. Timeslot scheduler 402 can select output timeslot queue 1 and output port 10 for packet type A but select output timeslot queue 1 and output port 20 for packet type B.

In a case where an output timeslot queue is dropping packets, the output timeslot queue can be considered to have capacity for allocation of packets and timeslot scheduler 402 can consider that output timeslot queue for allocating packets.

In state-full processing (e.g., packets have a shared context, flow, or connection (e.g., TCP)), flow affinity can be maintained by packets for a particular flow being provided to a destination queue and output transmission port according to timeslot order whereby packets from an earliest timeslot are allocated or processed before packets from a next earliest timeslot and so forth. In some embodiments, a context for a packet type or flow can be shared among cores that process different time slots. For example, if a core 0 processes a TCP flow for timeslot 0 and a core 1 processes packets of the same TCP flow for timeslot 1, then the TCP context (e.g., sequence number, congestion window, outstanding packets, out of order queue information, and so forth) can be shared among one or more caches used by core 0 and core 1. In some cases, processing of packets for timeslot 1 can be delayed until processing of packets of timeslot 0 are completed and updated context after processing of packets of timeslot 0 can be made available for using in processing packets of the same type or flow for timeslot 1.

In some cases, multiple sequential timeslots of the same context can be allocated for processing by a particular core. For example, packets of a TCP flow received in consecutive timeslots 0 to 5 can be allocated for processing by a core 0, whereas packets of the TCP flow received in consecutive timeslots 6 to 10 can be allocated for processing by a core 1. In some cases, processing of packets in timeslots 6 to 10 can be delayed until completion of processing of packets of timeslots 0 to 5 are completed and updated context after processing of packets of timeslots 0 to 5 can be made available for using in processing packets of the same type or flow for timeslots 6 to 10.

In a case of state-less packet processing (e.g., packets have no shared context, flow, or connection, or such characteristics can be ignored (e.g., UDP)), packets are ordered for a destination queue or transmission using standard re-ordering methods (e.g., arrival timestamp based re-ordering or arrival sequence number based reordering). In some embodiments, packet processing using multiple cores can occur independently for example for operations such as but not limited to IP filter application, packet classification, packet forwarding, and so forth.

Worker cores 404-0 to 404-P can be allocated to process packets associated with an output timeslot queues 403-0 to 403-P. Output timeslot queues 403-0 to 403-P can be stored in host memory. Worker cores 404-0 to 404-P can perform DPDK related processes such as but not limited to one or more of: encryption, cipher, traffic metering, traffic marking, traffic scheduling, traffic shaping, or payload compression. Transmit (TX) cores 406-0 to 406-P can perform synchronization of packets on a timeslot and packet processing for transmission, management of access control lists/IP filter rules, count packets transmitted, count and discard packets in the case of link failure, cause packets to be broadcast, or cause packets to be multi-cast. In some examples, worker core and TX core can be implemented using multiple threads on a single core. Other operations performed by worker cores 404-0 to 404-P can include one or more of: modifying the layer 3-layer 7 protocol headers or modification of payload data by encryption, decryption, compression or decompression operations. Processed packets from worker cores 404-0 to 404-P and TX cores 406-0 to 406-P can be stored in host memory and associated with an output timeslot queue for a particular output port as determined by timeslot scheduler 402.

In some cases, for an input timeslot queue, a corresponding RX core, worker core, and TX core can be implemented as threads or processes executed on a single core in a CPU or a network interface.

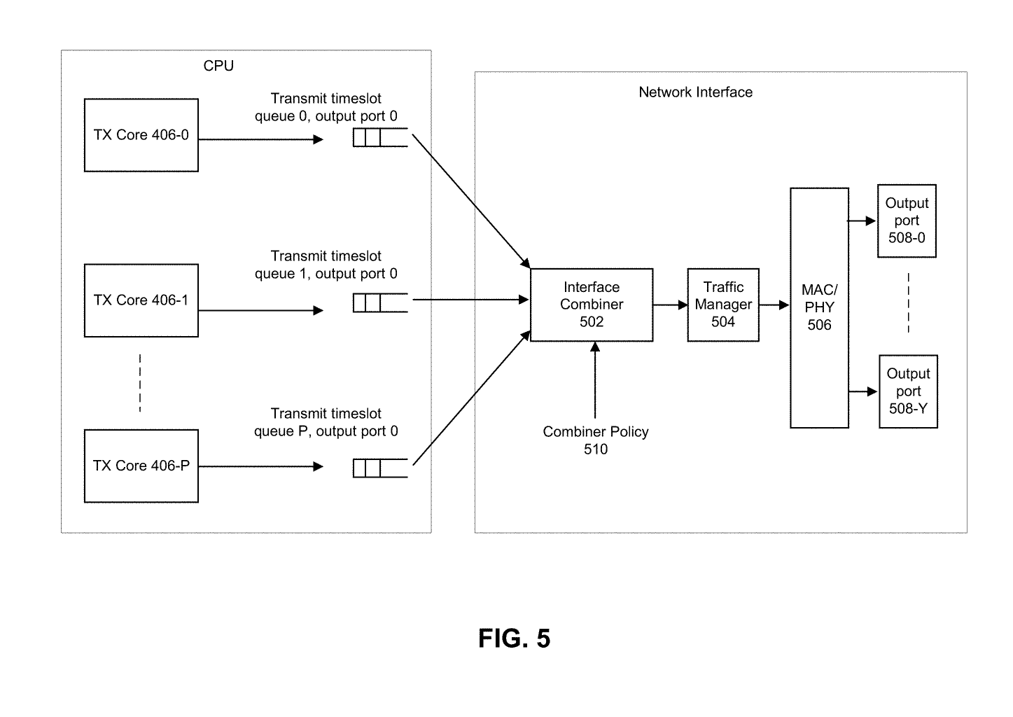

FIG. 5 depicts an example whereby packets from transmit timeslot queues are allocated for transmission from output ports. A network interface can use interface combiner 502 can apply a combiner policy 510 to combine the traffic from multiple transmit timeslot queues by selecting packets from a transmit timeslot for transmission from an output port. In some examples, combiner policy 510 specifies one or more of: timeslot size, number of timeslots to use, number of queues associated with the timeslots, or address/index of the queues. After processing by worker core and TX core, packets are placed into a transmit timeslot queue (e.g., in host memory) for an output port selected by the timeslot scheduler. This example depicts transmit timeslot queues for output port 0 but other transmit timeslot queues for other output ports are supported by the system of FIG. 5. A host CPU can configure interface combiner 502 and combiner policy 510. Combiner policy 510 specifies how the traffic should be combined. Accordingly, an order of packet receipt and can be maintained at transmission by maintaining a timeslot number for receive timeslot queues and corresponding transmit timeslot queues.

For a particular output port, interface combiner 502 can check output timeslot queues round-robin, from timeslot 0 to timeslot P and select packets from each output timeslot queue. If the number of outstanding packets exceeds the number of packets that can be sent from a timeslot, the outstanding packets are left in the queue, to be processed on the next scheduling round. Interface combiner 502 can monitor the traffic rate received from the output timeslot queues to limit the outgoing traffic allocated for transmission from an output timeslot queue. To match the outgoing line rate of the output port, interface combiner 502 limits the number of packets transmitted from an output timeslot queue to not exceed the rate permitted by the output timeslot queue. In other words, regardless of how many packets are queued for transmission from a particular output timeslot queue, interface combiner 502 will only schedule the packets that fit in the outgoing timeslot allocated to that output timeslot queue by interface combiner 502. Interface combiner 502 can perform output port scheduling, enforcing the maximum number of packets sent from each queue during a timeslot.

In some cases, the transmit timeslot size can be different than the receive timeslot size. For example, if a transmit rate from an output port differs a receive transmit rate from an input port, the transmit timeslot size can differ from the receive timeslot size.

Traffic manager 504 can perform one or more of: metering, marking, scheduling and shaping based on Class of Service. MAC/PHY 506 can perform media access layer encoding on packets for transmission from a port to a medium and prepare the signal and physical characteristics of the packets for transmission from an output port 508-0 to 508-Y to a network medium (e.g., wired or wireless).

An example sequence can be as follows. The host CPU configures combiner policy 510 to divide a single outgoing 100 Gbps port between ten 10 Gbps output timeslot queues. The host writes a combiner rule into combiner policy 510 that specifies all traffic on 100 Gbps Port 508-0 of type UDP and traffic class real-time uses the combiner policy. The combiner policy can indicate: timeslot size of 1 microsecond, total timeslots of 10 (e.g., 10 queues with one queue for each timeslot), and address/index of each queue. Interface combiner 502 starts a 1 microsecond internal clock, which increments a timeslot sequence number every 1 microsecond, then resets after 10 increments. When a packet is available to transmit, interface combiner 502 checks combiner policy 510 and runs the policy. If the rule matches, interface combiner 502 accesses a packet associated with the current transmit timeslot queue and allocates available packets into an outgoing port timeslot for transmission. When the timeslot timer expires, interfaces combiner 502 checks the next transmit timeslot queue for available packets to transmit. Accordingly, on transmission, interface combiner 502 transmits packets based on strict timeslot order so that packets placed in a timeslot are transmitted in-order according to a timeslot index order (e.g., sequentially starting at the lowest time slot number and increasing).

The timing and synchronization of the incoming ports, outgoing ports and CPU clocks can be synchronized using IEEE1588V2 and PTP protocol.

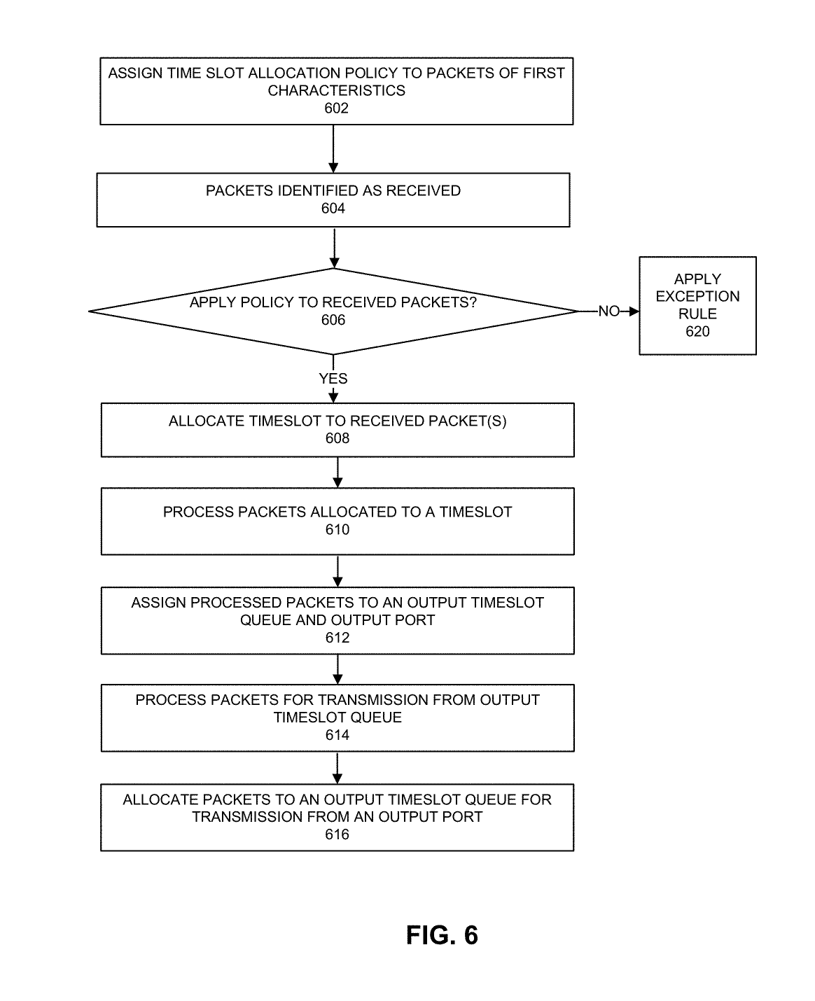

FIG. 6 depicts an example process. At 602, a timeslot allocation policy is assigned for received packets having first characteristics. For example, a timeslot allocation policy can define one or more of: input port to divide, IP 5tuple of the received traffic, protocol type of traffic to divide (e.g., TCP, UDP, ICMP), QoS field of the traffic (e.g. Differentiated Services Code Point (DSCP) field which provides the packet priority, Priority Code Point (PCP) field in the 802.1Q tag, or Traffic Class (e.g., real time, best effort)), and timeslot policy. A timeslot policy can specify one or more of: timeslot duration (e.g., microseconds, nanoseconds), number of timeslots to use, number of queues associated with the timeslots, or address/index of the queues.

At 604, one or more packets are identified as received. At 606, a determination is made as to whether to apply a timeslot allocation policy. For example, if a received packet satisfies any characteristics of the timeslot allocation policy, the timeslot allocation is applied. If a timeslot allocation policy is not to be applied to the received packet, then an exception rule is applied at 620, which can specific the packet is dropped or directed to a different queue or distributed using a different method. If a timeslot allocation policy is to be applied to the one or more received packets, then 608 follows.

At 608, a timeslot is selected for the one or more received packets based on the timeslot policy. A timeslot can be assigned to a received packet based on based on the received packet's timestamp. A packet descriptor or meta-data can be formed that identifies an addressable region in memory that stores the one or more received packets and identifies a timeslot of a received packet. The one or more packets can be stored in a region of memory (e.g., queue) associated with a timeslot. At 610, the received packets allocated to a timeslot are processed by one or more cores associated with the timeslot. The one or more cores can process contents of packets (e.g., header or payload) in the region of memory associated with the timeslot. Processed contents of one or more received packets can be stored in a region of memory. Processing of received packets can include one or more of: metering, marking, encryption, decryption, compression, decompression, packet inspection, denial of service protection, rate limiting, scheduling based on priority, traffic shaping, or packet filtering based on IP filter rules.

At 612, the processed packets are assigned to an output timeslot queue and output port. Assignment of an output timeslot and output port to received packets associated with an input timeslot can be made using a mapping table that maps packets from an input timeslot and input port to a particular output timeslot and output port. Packets allocated to an input timeslot number from an input port can be allocated to the same output timeslot number and the same output port. In some cases, packets of a particular type from an input timeslot can be assigned to the same output timeslot queue whereas packets of a different type from the same input timeslot can be assigned to a different output timeslot queue. In a case where an output timeslot queue is overflowing or full, any received packets can be assigned to a different output timeslot queue such that earlier-received packets assigned to a first input timeslot queue are assigned to a first output timeslot queue and at or after the first output timeslot queue is detected to overflow or is full, later-received packets from the same input timeslot are assigned to a second output timeslot queue and output port. The second output timeslot queue can be close in index to the first output timeslot, but after the index of the first output timeslot, so that transmission order is attempted to be preserved.

At 614, packets allocated to an output timeslot queue can be processed for transmission. For example, processing packets for transmission can include one or more of: DPDK related processes such as but not limited to one or more of: encryption, cipher, traffic metering, traffic marking, traffic scheduling, traffic shaping, or payload compression; synchronization of packets on a timeslot and packet processing for transmission; management of access control lists/IP filter rules; count of transmitted packets; count and discard packets in the case of link failure; cause packets to be broadcast; cause packets to be multi-cast; modifying the layer 3-layer 7 protocol headers or modification of payload data by encryption, decryption, compression or decompression operations.

At 616, for an output port, packets allocated to an output timeslot queue are selected for transmission. For example, for a time increment, packets allocated to a first output timeslot queue can be selected for transmission, followed by, for the time increment, packets allocated to a second output timeslot queue, and so forth. Contents of multiple output timeslot queues can be multiplexed to transmit from a higher rate output port.

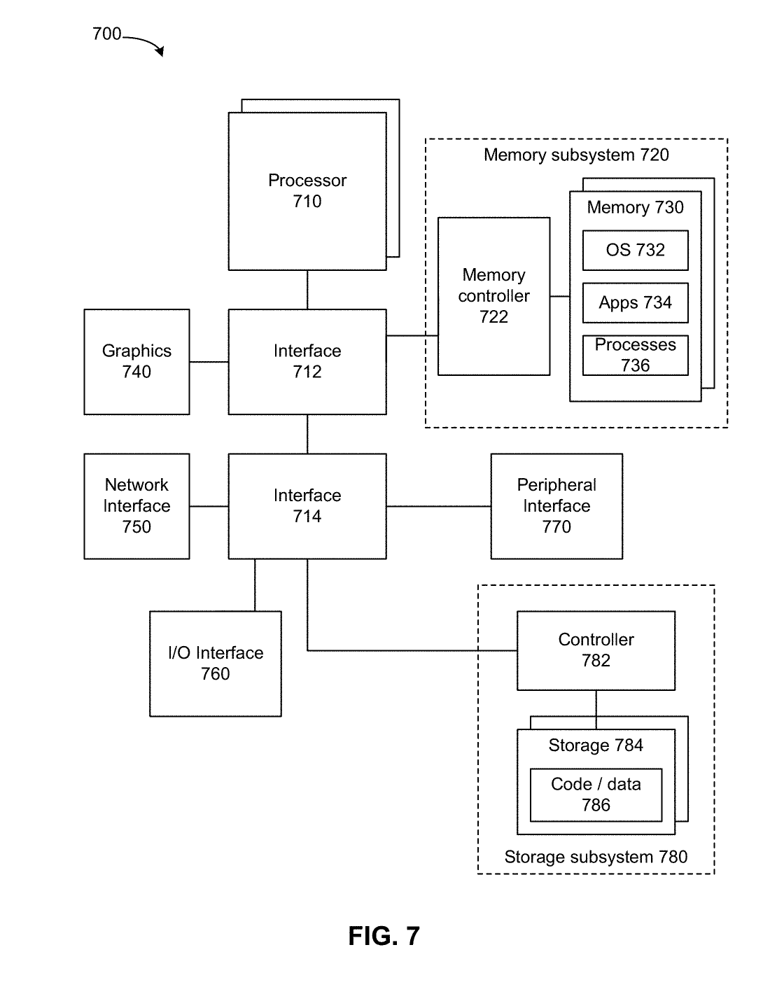

FIG. 7 depicts a system. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1374 bus.

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (i.e., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as PCIe, Ethernet, or optical interconnects (or a combination thereof).

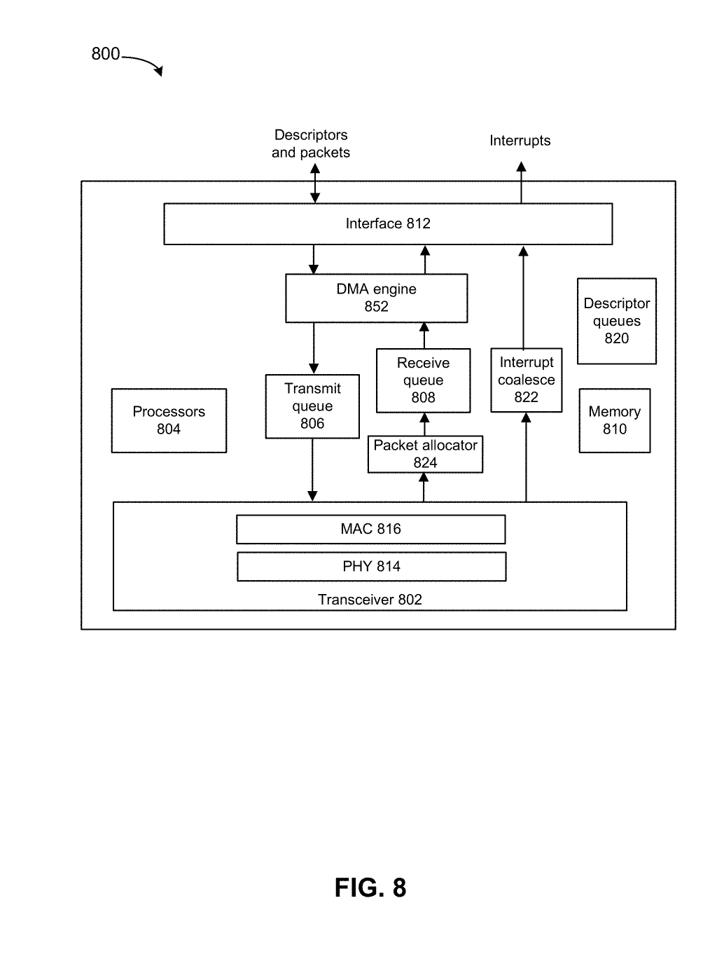

FIG. 8 depicts a network interface. Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values. Processors 804 can be any a combination of a: processor, core, graphics processing unit (GPU), field programmable gate array (FPGA), application specific integrated circuit (ASIC), or other programmable hardware device that allow programming of network interface 800. For example, processors 804 can provide for identification of a resource to use to perform a workload and generation of a bitstream for execution on the selected resource. For example, a “smart network interface” can provide packet processing capabilities in the network interface using processors 804.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

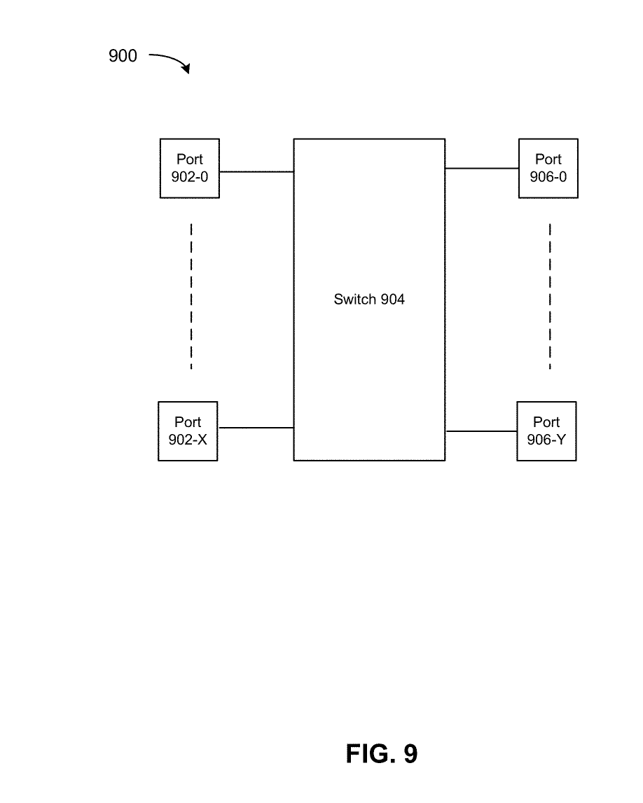

FIG. 9 depicts a switch. Various embodiments can be used in or with the switch of FIG. 9. Switch 904 can route packets or frames of any format or in accordance with any specification from any port 902-0 to 902-X to any of ports 906-0 to 906-Y (or vice versa). Any of ports 902-0 to 902-X can be connected to a network of one or more interconnected devices. Similarly, any of ports 906-0 to 906-X can be connected to a network of one or more interconnected devices. Switch 904 can decide which port to transfer packets or frames to using a table that maps packet characteristics with an associated output port. In addition, switch 904 can perform packet replication for forwarding of a packet or frame to multiple ports and queuing of packets or frames prior to transfer to an output port.

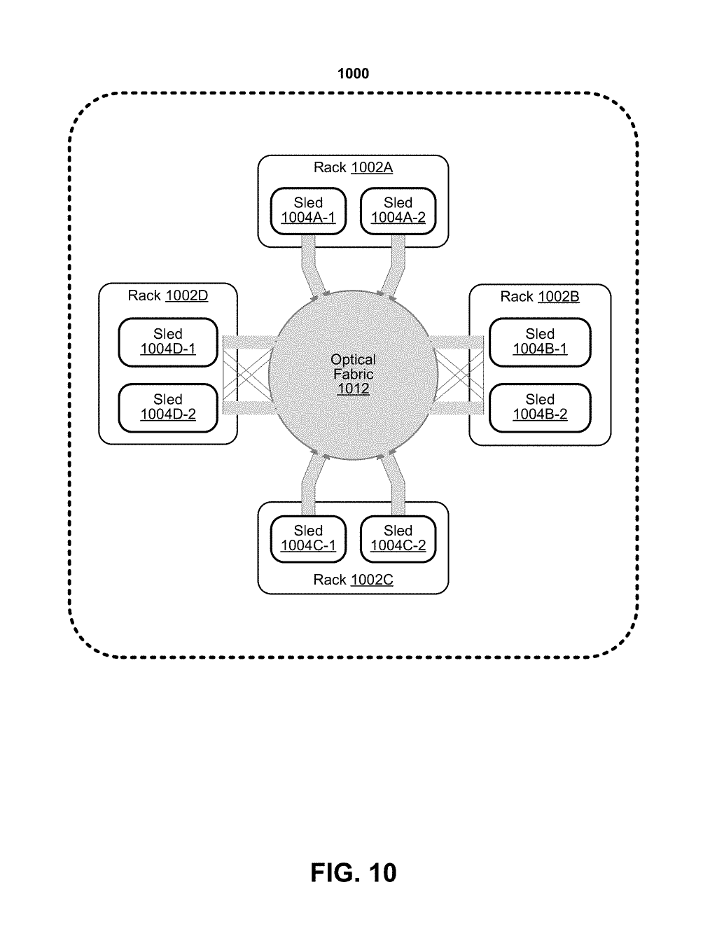

FIG. 10 depicts an example of a data center. Various embodiments can be used in or with the data center of FIG. 10. As shown in FIG. 100, data center 1000 may include an optical fabric 1012. Optical fabric 1012 may generally include a combination of optical signaling media (such as optical cabling) and optical switching infrastructure via which any particular sled in data center 1000 can send signals to (and receive signals from) each of the other sleds in data center 1000. The signaling connectivity that optical fabric 1012 provides to any given sled may include connectivity both to other sleds in a same rack and sleds in other racks. Data center 1000 includes four racks 1002A to 1002D and racks 1002A to 1002D house respective pairs of sleds 1004A-1 and 1004A-2, 1004B-1 and 1004B-2, 1004C-1 and 1004C-2, and 1004D-1 and 1004D-2. Thus, in this example, data center 1000 includes a total of eight sleds. Optical fabric 10012 can provide each sled signaling connectivity with one or more of the seven other sleds. For example, via optical fabric 10012, sled 1004A-1 in rack 1002A may possess signaling connectivity with sled 1004A-2 in rack 1002A, as well as the six other sleds 1004B-1, 1004B-2, 1004C-1, 1004C-2, 1004D-1, and 1004D-2 that are distributed among the other racks 1002B, 1002C, and 1002D of data center 1000. The embodiments are not limited to this example. For example, fabric 1012 can provide optical and/or electrical signaling.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

What is claimed is:

1. A network interface comprising:
an input port and
a timeslot allocator to allocate packets received at the input port to a first input timeslot queue based on packet timestamps and to allocate packets received at the input port to a second input timeslot queue based on packet timestamps.

2. The network interface of claim 1, wherein a size of a timeslot is based on one or more of: utilization of one or more cores or number of packets allocated to a timeslot.

3. The network interface of claim 1, comprising a scheduler to allocate packets from the first input timeslot queue to an output timeslot queue to maintain an order of received packets within a timeslot.

4. The network interface of claim 1, comprising a scheduler to allocate processed packets of the first input timeslot queue to a first output timeslot queue and allocate processed packets of the second input timeslot queue to a second output timeslot queue and comprising an interface to select packets from the first output timeslot queue for transmission using an output port and to select packets from the second output timeslot queue for transmission using the output port.

5. The network interface of claim 1, comprising a scheduler to assign packets having a first characteristic and associated with the first input timeslot queue to a first output timeslot queue and to assign packets having a second characteristic and associated with the second input timeslot queue to a second output timeslot queue.

6. The network interface of claim 1, comprising a scheduler to assign one or more packets associated with the first input timeslot queue to a first output timeslot queue and, based on a fullness level of the first output timeslot queue meeting or exceeding a threshold, assign packets associated with the first input timeslot queue to a second output timeslot queue.

7. The network interface of claim 1, comprising a combiner to select one or more packets for transmission using a first port from a first output timeslot queue and to select one or more packets for transmission using the first port from a second output transmit queue.

8. The network interface of claim 1, wherein:
the first core is to perform one or more of: determination if a packet is valid, determination of packet destination, use of Data Plane Development Kit (DPDK), or use OpenDataPlane; and
the second core is to perform one or more of: determination if a packet is valid, determination of packet destination, use of Data Plane Development Kit (DPDK), or use OpenDataPlane.

9. The network interface of claim 1, comprising:
a first core to process packets associated with the first input timeslot queue; and
a second core to process packets associated with the second input timeslot queue.

10. A method comprising:
at a network interface, assigning a first group of one or more received packets to a first timeslot queue;
at the network interface, assigning a second group of one or more received packets to a second timeslot queue;
processing the received packets from the first timeslot queue;
processing the received packets from the second timeslot queue;
assigning the processed received packets assigned to the first timeslot queue to a first output timeslot queue;
assigning the processed received packets assigned to the second timeslot queue to a second output timeslot queue;
selecting one or more packets from the first output timeslot queue for transmission from a first port; and
selecting one or more packets from the second output timeslot queue for transmission from the first port.

11. The method of claim 10, comprising maintaining an order of received packets during transmission of the packets from the first port based on an associated timeslot.

12. The method of claim 10, wherein:
assigning a first group of one or more received packets to a first timeslot queue comprises assigning a first group of one or more received packets having first characteristics and having a time stamp associated with a first timeslot to the first timeslot queue and
assigning a second group of one or more received packets to a second timeslot queue comprises assigning a second group of one or more received packets having the first characteristics and having a time stamp associated with a second timeslot to the second timeslot queue.

13. The method of claim 12, wherein the first characteristics comprise one or more of: input port, 5tuple of the received packets, protocol type, quality of service (QoS), or traffic class.

14. The method of claim 10, wherein:
processing the received packets from the first timeslot queue comprises one or more of: determining if a packet is valid, determining a packet destination, using any portion of Data Plane Development Kit (DPDK), or using any portion of OpenDataPlane and
processing the received packets from the second timeslot queue comprises one or more of: determining if a packet is valid, determining a packet destination, using any portion of Data Plane Development Kit (DPDK), or using any portion of OpenDataPlane.

15. The method of claim 10, wherein:
assigning the processed packets assigned to the first timeslot queue to a first output timeslot queue comprises selecting an output timeslot queue based at least, in part, on utilization of a core that processes the first output timeslot queue and
assigning the processed packets assigned to the second timeslot queue to a second output timeslot queue comprises selecting an output timeslot queue based at least, in part, on utilization of a core that processes the second output timeslot queue.

16. The method of claim 10, wherein:
based on utilization of a core that processes the first output timeslot queue exceeding a threshold, assigning a third output timeslot queue to packets associated with the first timeslot queue.

17. A system comprising:
a network interface comprising a port to receive packets and one or more processors, the one or more processors to selectively allocate one or more received packets to an input timeslot among multiple timeslots;
a memory; and
one or more cores communicatively coupled to the network interface and the memory, the one or more cores to:
process the one or more received packets allocated to the input timeslot and
selectively allocate the one or more received packets to an output timeslot index among multiple output timeslots based at least, in part, on an input timeslot index of the received packet.

18. The system of claim 17, wherein to selectively allocate one or more received packets to an input timeslot among multiple timeslots, the one or more processors are to determine if the one or more received packets are to be allocated to a timeslot based on packet characteristics of the one or more received packets.

19. The system of claim 17, wherein the one or more processors are to adjust a duration of a timeslot based on utilization of at least one of the one or more cores.

20. The system of claim 17, comprising a compute sled.
